(19) United States
(12) Patent Application Publication
(10) Pub. No.: US 2006/0255891 A1
(43) Pub. Date: Nov. 16, 2006

(54) Electrical component seal boot

(76) Inventor: Donald E. Porterfield, Lascassas, TN (US)

Correspondence Address: LOCKE LIDDELL & SAPP LLP;ATTN. DOCKETING, 600 TRAVIS #3400, HOUSTON, TX, 77002, US

(21) Appl. No.: 11/374,443

(22) Filed: Mar. 13, 2006

Related U.S. Application Data
(60) Provisional application No. 60/662,399, filed on Mar. 16, 2005.

(51) Int. Cl. H01H 7/16

(52) U.S. Cl. 335/156

(57) ABSTRACT

The present disclosure provides a method, apparatus, and system to improve the sealing over electrical equipment, such as circuit breaker, exposed to moisture and elements. In one embodiment, a seal includes a self-contained boot that is placed at the factory over a circuit breaker and is provided to the contractor as an assembly. The seal boot seals around the circuit breaker and over the circuit breaker such that air is restricted from entering around and through the circuit breaker. The seal boot is sufficiently pliable to allow an operator to rotate or otherwise operate the circuit breaker without breaching the seal of the boot around and over the circuit breaker.

### SPECIFICATION

This application claims the benefit of U.S. Provisional Application No. 60/662,399 filed Mar. 16, 2005.

### FIELD

This disclosure relates to protective covers for equipment. More specifically, the disclosure relates to moisture resistance covers for electrical panels.

### BACKGROUND

The reliance on electrical connections is fundamental to our modern society for power control and transfer. The integrity of the electrical connections need to be maintained for decades in certain equipment, such as air handling equipment for heating ventilation and air conditioning (HVAC). Typically, air handling equipment is controlled by control panels mounted to the air handling equipment case. The control panels can include power switches such as circuit breakers, electronic controllers, sensors, and other equipment to control the operation of the air handling equipment. Because the air handling unit operates with a negative pressure in drawing air into the system, any unsealed areas through the control panels is subject to allowing unwanted and untreated air to enter through the control panels and cause corrosion or other unwanted effects on the electrical circuitry, controls, and connections. A clean room is not practical especially for air handling systems and pretreated air can be costly. A prime source of unwanted air is through unsealed circuit breakers, which are necessarily exposed to the exterior portions of the control panel for accessibility. It is difficult for the factory to provide the seal because of on-site installations of equipment that necessitate new cutouts in the control panels and installations of additional equipment, including additional circuit breakers.

Some sealing of the panels surrounding circuit breakers has become available in the last few years. Typically, an installation contractor forms a cutout in the control panel and mounts a circuit breaker thereto. The contractor then peels a backing tape off a seal with adhesive and attaches the seal to the periphery of the circuit breaker or the cutout. While this procedure assists in reducing unwanted air, it is sorely inadequate for several reasons. First, the seal surrounds the circuit breaker and does not seal air through the circuit breaker. Further, many of the locations for air handling equipment are difficult to access. An installer can have difficulty installing the additional seal over the equipment and insuring that it is firmly and sealing attached throughout its entire length. Also, any subsequent repair and replacement need new seals, which necessitates the contractor having the right shape and size that is not always readily available. In short, the seal is not practically adequate for the intended purpose.

Therefore, there remains a need for improved seal for external electrical equipment, particularly circuit breakers and other control devices.

### SUMMARY

The present disclosure provides a method, apparatus, and system to improve the sealing over electrical equipment, such as circuit breaker, exposed to moisture and elements. In one embodiment, a seal includes a self-contained boot that is placed at the factory over a circuit breaker and is provided to the contractor as an assembly. The seal boot seals around the circuit breaker and over the circuit breaker such that air is restricted from entering around and through the circuit breaker. The seal boot is sufficiently pliable to allow an operator to rotate or otherwise operate the circuit breaker without breaching the seal of the boot around and over the circuit breaker.

The disclosure provides an electrical component adapted to be mounted in a cutout for a control panel for electrical equipment, the electrical component comprising a seal boot coupled thereto independent of the control panel, the seal boot at least partially covering the electrical component on at least one face and sized to sealingly engage the cutout with the electrical component mounted therein.

The disclosure also provides a method of sealing an electrical component for a control panel exposed to ambient conditions, comprising: providing the electrical component; coupling a seal boot to the electrical component and covering the face of the electrical component designed to be exposed to the ambient conditions prior to installing the electrical component in the control panel; and allowing the electrical component to be manually actuated while maintaining the covering of the seal boot over the component.

The disclosure further provides a system for sealing electrical components mounted in a control panel, comprising: a control panel having at least one cutout adapted to receive an electrical component; and an electrical component adapted to be mounted in the cutout, the electrical component comprising a seal boot coupled thereto independent of the control panel, the seal boot at least partially covering the electrical component on at least one face and sized to sealingly engage the cutout with the electrical component mounted therein.

### BRIEF DESCRIPTION OF THE DRAWINGS

A more particular description, briefly summarized above, may be had by reference to the embodiments illustrated in the appended drawings, forming part of the present specification and described herein. It is to be noted, however, that the appended drawings illustrate only some embodiments described herein and are therefore not to be considered limiting of the disclosure's scope, in that there can be other equally effective embodiments.

FIG. 1 is a perspective schematic view of one embodiment of an electrical system having a control panel with a circuit breaker or other electrical equipment covered with a seal boot.

FIG. 2 is a cross sectional schematic view of the electrical equipment covered with a seal boot of FIG. 1.

FIG. 3 is a perspective schematic view of the electrical equipment covered with a seal boot.

FIG. 4 is a cross sectional schematic view of the electrical equipment coupled with a seal boot.

### DETAILED DESCRIPTION

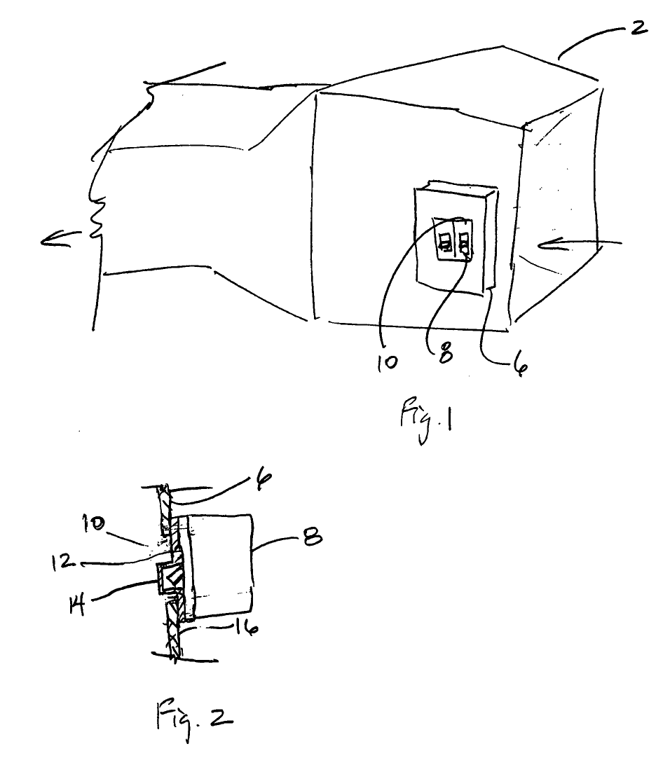

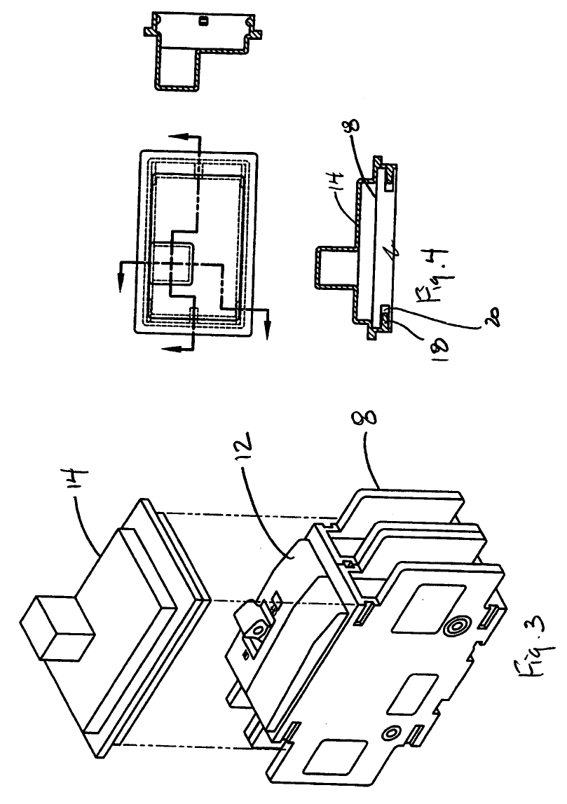

FIG. 1 is a perspective schematic view of one embodiment of an electrical system having a control panel with a circuit breaker or other electrical equipment covered with a seal boot. FIG. 2 is a cross sectional schematic view of the electrical equipment covered with a seal boot of FIG. 1. FIG. 3 is a perspective schematic view of the electrical equipment covered with a seal boot. FIG. 4 is a cross sectional schematic view of the electrical equipment coupled with a seal boot. The figures will be described in conjunction with each other.

The electrical system 2 can be any electrical equipment, such as motors, air handling unit, or other equipment. Generally, one or more control panels 6 are generally coupled to the electrical system 2 to control the electrical system 2. The term “coupled,” “coupling,” and like terms are used broadly herein and can include any method or device for securing, binding, bonding, fastening, attaching, joining, inserting therein, forming thereon or therein, communicating, or otherwise associating, for example, mechanically, magnetically, electrically, chemically, directly or indirectly with intermediate elements, one or more pieces of members together and can further include integrally forming one functional member with another.

The control panels 6 generally include one or more electrical circuit breakers 8 or other equipment coupled to exterior surfaces of the control panel for accessibility. Such location exposes the circuit breakers to ambient conditions, including moisture and other corrosive elements as well as dust and particulates. The circuit breakers 8 are mounted in open spaces 10 (also known as “cutouts”) of the control panel, so that a face 12 of the circuit breaker would be otherwise exposed to the ambient conditions as an external surface. Sometimes, the cutouts 10 are factory provided and at other times, the cutouts are made at a jobsite.

The present disclosure provides a seal boot 14 to surround at least a portion of the face 12 of the circuit breaker 8. The seal boot 14 is generally mounted at the factory and provided with the circuit breaker 8 to the contractor independent of the control panel. Thus, the contractor can install the circuit breaker and seal boot as a unitary part without necessitating a subsequent and sometimes inadequate attachment of a separate seal, as in prior efforts. The seal boot 14 will generally be installed between the face of the circuit breaker and the surface of the control panel wall 16 to sandwich a portion of the seal boot therebetween. Additionally, the seal boot 14 covers the circuit breaker 8 in contrast to prior efforts that simply provided a gasket (at best) around the periphery of the circuit breaker or other electrical component. The prior efforts of a peripheral attachment allowed air to flow through the circuit breaker and into other electrical components within the control panel 6 or otherwise allowed exposure of the electrical components to the unwanted ambient conditions. Thus, the seal boot covers the face of the circuit breaker or other electrical component that would otherwise be exposed to the ambient conditions.

In at least one embodiment, the seal boot can be made of an elastomeric compound, such as and without limitation, latex, silicon, nitrile, vinyl, rubber, and other flexible and pliable materials. Preferably, the material is sufficiently clear to be able to see the position of the actuation of the circuit breaker therein. The thickness can vary depending on the application and size. In some embodiments, the thickness can vary within the same seal boot where one portion can have a first thickness and another portion can have a second thickness, thicker than the first thickness. For example, the first thickness can be for a peripheral seal area and the second thickness can be for the portion covering the circuit breaker where more wear can occur, or vice versa.

In one exemplary embodiment, the seal boot 14 can be coupled to the circuit breaker 8 by mechanical attachment. For example, a tang 18 on the seal boot 14 can be formed and sized to engage a slot 20 formed in the circuit breaker. Other types of coupling can be made between the seal boot 14 and the circuit breaker 8.

The term “circuit breaker” has been used herein as an exemplary electrical component utilizing the protection provided by the seal boot 14. It is to be understood that the seal boot can be applied with other electrical components and such use is only limited by the claims.

Various basics of the invention have been explained herein. The various techniques and devices disclosed represent a portion of that which those skilled in the art would readily understand from the teachings of this application. Details for the implementation thereof can be added by those with ordinary skill in the art. Such details may be added to the disclosure in another application based on this provisional application and it is believed that the inclusion of such details does not add new subject matter to the application. The accompanying figures may contain additional information not specifically discussed in the text and such information may be described in a later application without adding new subject matter. Additionally, various combinations and permutations of all elements or applications can be created and presented. All can be done to optimize performance in a specific application.

The various steps described herein can be combined with other steps, can occur in a variety of sequences unless otherwise specifically limited, various steps can be interlineated with the stated steps, and the stated steps can be split into multiple steps. Unless the context requires otherwise, the word “comprise” or variations such as “comprises” or “comprising”, should be understood to imply the inclusion of at least the stated element or step or group of elements or steps or equivalents thereof, and not the exclusion of any other element or step or group of elements or steps or equivalents thereof.

Further, any documents to which reference is made in the application for this patent as well as all references listed in any list of references filed with the application are hereby incorporated by reference. However, to the extent statements might be considered inconsistent with the patenting of this invention such statements are expressly not to be considered as made by the applicant(s).

Also, any directions such as “top,” “bottom,” “left,” “right,” “upper,” “lower,” and other directions and orientations are described herein for clarity in reference to the figures and are not to be limiting of the actual device or system or use of the device or system. The device or system may be used in a number of directions and orientations.

1. An electrical component adapted to be mounted in a cutout for a control panel for electrical equipment, the electrical component comprising a seal boot coupled thereto independent of the control panel, the seal boot at least partially covering the electrical component on at least one face and sized to sealingly engage the cutout with the electrical component mounted therein.

2. The electrical component of claim 1, wherein the seal boot is coupled to the electrical component prior to installation in the cutout.

3. The electrical component of claim 1, wherein the seal boot is coupled to the electrical component by an engagement of a tang on one of the seal boot or the electrical component with a slot on the other member.

4. The electrical component of claim 1, wherein the seal boot is adapted to be mounted between the face of the electrical component and a surface of the control panel and cover a face of the electrical component exposed to ambient conditions.

5. The electrical component of claim 1, wherein the electrical component comprises a circuit breaker.

6. The electrical component of claim 1, wherein the seal boot is adapted to allow manual actuation of the electrical component while covering the electrical component.

7. A method of sealing an electrical component for a control panel exposed to ambient conditions, comprising:
a. providing the electrical component;
b. coupling a seal boot to the electrical component and covering the face of the electrical component designed to be exposed to the ambient conditions prior to installing the electrical component in the control panel; and
c. allowing the electrical component to be manually actuated while maintaining the covering of the seal boot over the component.

8. The method of claim 7, coupling the seal boot to the electrical component by engaging a tang on one of the seal boot or the electrical component with a slot on the other member.

9. The method of claim 7, further comprising installing the electrical component with the seal boot into a cutout in the control panel.

10. The method of claim 9, further comprising securing the seal boot between the control panel and the electrical component when the electrical component is installed to the control panel.

11. A system for sealing electrical components mounted in a control panel, comprising:
a. a control panel having at least one cutout adapted to receive an electrical component; and
b. an electrical component adapted to be mounted in the cutout, the electrical component comprising a seal boot coupled thereto independent of the control panel, the seal boot at least partially covering the electrical component on at least one face and sized to sealingly engage the cutout with the electrical component mounted therein.

12. The system of claim 1, further comprising a plurality of electrical components having seal boots coupled thereto and adapted to be interchangeably mounted into the cutout of the control panel.

13. The system of claim 11, wherein the seal boot is coupled to the electrical component by an engagement of a tang on one of the seal boot or the electrical component with a slot on the other member.

14. The system of claim 11, wherein the seal boot is adapted to be mounted between the face of the electrical component and a surface of the control panel and cover a face of the electrical component exposed to ambient conditions.

15. The system of claim 11, wherein the electrical component comprises a circuit breaker.

16. The system of claim 11, wherein the seal boot is adapted to allow manual actuation of the electrical component while covering the electrical component.

17. The system of claim 11, wherein the seal boot is coupled to the electrical component prior to installation in the cutout.
